(19) United States
(12) Patent Application Publication
(10) Pub. No.: US 2005/0020240 A1
(43) Pub. Date: Jan. 27, 2005

(54) Private wireless network

(76) Inventor: Darin Minter, Grayslake, IN (US)

Correspondence Address: FOLEY & LARDNER, 321 NORTH CLARK STREET, SUITE 2800, CHICAGO, IL, 60610-4764, US

(21) Appl. No.: 10/360,695

(22) Filed: Feb. 7, 2003

(51) Int. Cl. H04M 9/00

(52) U.S. Cl. 455/404.1

(57) ABSTRACT

A system is provided to redirect a mobile station in range of a privately owned physical space/proximity onto a “reconstituted” private wireless network. The reconstituted private wireless network is contained and procured for the purpose of controlling incoming and out going cellular traffic to those mobile stations. Thus, a “quiet zone” is created whose size is defined by the coverage or radio frequency footprint of the privately wireless network within the physical space.

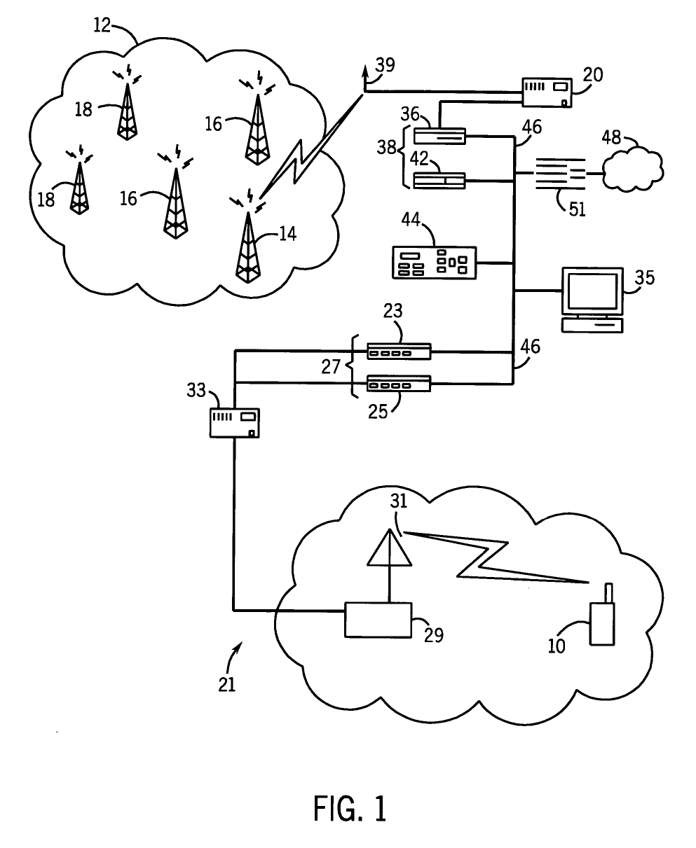

### FIELD OF THE INVENTION

The present invention relates generally to a private wireless network to control incoming and out going wireless communications.

### BACKGROUND OF THE INVENTION

Cellular phones, beepers, pagers, portable computers, electronic personal attendants, and other wireless communication devices offer convenience by allowing communication in practically any public location. However, one person's convenience can be another person's annoyance. Often, cellular phones ring and phone conversations occur in inappropriate locations. For example, it has become common for audiences at a movie, play or musical performance to be disturbed by the ringing of cellular phones. At universities and even high schools, the ringing of cellular phones disturbs the classroom. During religious services, while dining at restaurants, and in many other circumstances the inappropriate ringing of cellular phones has become commonplace.

In addition, certain locations have restrictions, rules or laws forbidding the operation of wireless communication devices due to safety concerns. For example, in order to prevent the interference with electronic medical devices, hospitals and other health care facilities attempt to restrict the use of wireless communication devices. In order to prevent the interference with control tower communications, in air travel the use of wireless communication devices is restricted. Also, some schools forbid students to use cellular phones or beepers on school grounds, in order to reduce the likelihood of drug trafficking and gang activity. Further, many commercial and governmental establishments, such as libraries and courtrooms, restrict the use of cellular phones, beepers, and other types of wireless communication devices in order to avoid disruptions. Prevention of a wireless communications on military bases or other restricted governmental facilities is vital to security.

Therefore, there exists a need to control the ability to establish a wireless communication, either received or initiated, in a given area.

### SUMMARY OF THE INVENTION

A system is provided to redirect any mobile station in range of a privately owned physical space/proximity onto a “reconstituted” private wireless network. The “reconstituted” private wireless network is contained and procured for the purpose of inhibiting or prohibiting incoming and out going wireless communications to those mobile stations. Thus, a “quiet zone” is created whose size is defined by the coverage or wireless frequency footprint of the private wireless network within the physical space.

### DETAILED DESCRIPTION OF THE PREFERRED EMBODIMENTS

When used herein, wireless communications includes, but is not necessarily limited to control channel signaling (common, broadcast, random access and dedicated; uplink and downlink, inbound and outbound), packet channels, voice, and traffic channels. The mobile station referred to herein comprises wireless communication devices including but not necessarily limited to cellular phones, beepers, pagers, portable computers, electronic personal attendants, and/or similar wireless devices.

Wireless communications are predicated on predetermined control frequencies, to which the cellular units are directed or “listen” automatically, while they are in the standby mode. The control is two-way full duplex, such that there may be a plurality of forward control channels (FCC) from the cell to the portable unit (uplink), and a plurality of reverse control channels (RCC) from the telephone to the cell (downlink). The cellular units automatically adjust to the best channel available in the cell or sector.

Two types of wireless conversations take place. In the first type, a subscriber initiates a signal from the cellular unit to any telephone subscriber. In this case, the subscriber dials the destination subscriber number and presses the send button, and this begins a handshake routine opposite the local cellular cell, which provides service in a given area. The call handling is then passed to an area cellular mobile telephone switch office (MTSO), which checks the information, performs a verification that the subscriber is operating properly, and is entitled to receive service and then connects to the destination subscriber. This process is known as “call setup”.

In the second type, the subscriber receives a request to establish a conversation with a cellular subscriber, and the area cellular MTSO performs a subscriber locate/search activity by sending a “search call” to all the cellular cells (connected to it) and these broadcast it on their control frequencies. The destination subscribers (when in a standby mode) which are tuned to the local control frequency, respond to the search call and this begins a handshake routine with the area cellular MTSO. When finished, the system assigns a pair of specific frequencies, the FCC from the cell to the portable unit, and the RCC from the telephone to the cell, in full duplex mode, to which the telephone and cell are tuned. Only after this, a ring command is broadcast to the telephone, activating the cellular subscriber's ringing unit, which clears the way for a full conversation.

In establishing a cellular connection the control frequency and the service in a given area must be received by the subscriber with a volume which provides a required signal-to-noise ratio (S/N) or better. When a mobile station powers up, it reads its own internal configuration file that contains a list of radio frequencies (RF) to scan. The mobile station scans those frequencies to find the best carrier signal quality. The best carrier signal quality is estimated in accordance with the following equation:
C/I+N
where C is the received signal strength (RSSI), e.g., the average signal strength at the input of the receiver produced by measurement circuitry in the receiver;
I is the measured interference raw power level; and
N is the measured noise floor/noise level.

Upon finding the best carrier signal quality, the mobile station “connects” to the broadcast control channel associated with that carrier, downloads, and decodes the system information associated with that cell. The broadcast control channel (BCCH) is a downlink point to multipoint logical channel in for example Global System for Mobile communications (GSM) and cdma2000 systems used to send identification and organization information about common control channels and cell services to facilitate downlink transmission of system information broadcast parameters. GSM is the world's most widely used mobile system. The GSM is used on the 900 MHz and 1800 MHz frequencies in Europe, Asia and Australia, and the MHz 1900 frequency in North America and Latin America. Code division multiple access (CDMA) is one of several digital wireless transmission methods in which signals are encoded using a specific pseudo-random sequence, or code, to define a communication channel. cdma2000 is the name identifying the Telecommunications Industry Association standard for current CDMA systems providing a migration path to 3G services. 3G is the newest generation of wireless communications systems.

The mobile station measures the serving and neighbor cell BCCHs in order with the highest signal quality carriers placed in the foreground and the weakest signal quality carriers placed in the background. A neighbor cell is a candidate cell for reselection prescribed according to network configuration and provided to the mobile station in BCCH data. A foreground neighbor cell is a neighbor cell within a neighbor cell list with higher than average C/I ration of all neighbor cells in the list (or top two, configurable), and thus has a higher measurement rate. A foreground neighbor cell that develops most preferable C/I ratio (that also exceeds current serving cell) will become new serving cell. A background neighbor cell is a neighbor cell within a neighbor cell list with lower than average C/I of all neighbor cells in a neighbor cell list, and thus has a lower measurement rate. A background neighbor cell becomes a foreground neighbor cell when measured C/I ranks in the top-two. Background neighbor cells do not generally become immediate candidates for new serving cell until passing through foreground neighbor cell status first.

At any given moment in almost any given state, the mobile station measures its serving cell, its foreground neighbors and its background neighbors with the intent of finding and moving to the carrier with the best signal strength per pre-established measurement threshold criteria as configurable and determined by the commercial network (or any network/entity emitting BCCH signal). The mobile station then connects to a common control channel (CCCH) to listen for outbound page requests, while still listening to and measuring other BCCH carrier signals from foreground and background neighbor cells. No subscription, affiliation, provisioning or permission is required from the commercial carrier/owner of the network to perform these procedures.

The present invention consists of a system design and supporting protocol designed to lure a mobile station from its service provider network (“commercial network” or “CN”) onto a reconstituted private wireless network with the goal of controlling (i.e., inhibiting, filtering, prohibiting) incoming calls, outgoing calls, paging and messaging to/from that mobile station. Once the mobile station has been “lured” to the reconstituted private network, communication with its commercial network with which the mobile station was originally and is normally affiliated ceases. This is accomplished by moving the mobile station to a frequency such that the mobile station is out of range of the commercial network. Communication between the mobile station and its original commercial network ceases indefinitely or for as long as the mobile station is within a specified proximity to the reconstituted private network.

The system utilizes existing commercial network data readily available over the airwaves to lead the mobile station to the private network. The private network then assumes the role as the best carrier available to the mobile station. The private network then rebroadcasts modified system information that has been reconfigured by a central processing unit (CPU) having a required memory component needed to effectively process interrupt service routine/requests from system devices, run application code, manipulate and rewrite system information and forward to appropriate subsystems, perform system diagnostics, etc. An interrupt service routine/requests is an operating system level request message.

The process of reconfiguring and rebroadcast of the commercial network information provides the air interface platform required for enabling local content services such as voice, Short Messaging Service (SMS), Wireless Application Protocol (WAP) and other control and traffic channel based services such as pop-up ads. SMS is a store and forward message service available on most second generation digital systems that allows short messages (up to 140 octets) to be sent to the mobile and displayed on a small screen. WAP is a protocol for wireless communications that makes it possible to create advanced telecommunications services and to access Internet pages from a mobile telephone.

Referring now to the Figure, an overview of an example system in accordance with the principles of the present invention is seen. The system in accordance with the principles of the present invention is designed to work with a mobile station 10. A large “cloud” 12 represents a commercial network domain. The commercial network 12 includes a serving cell 14, at least one foreground neighboring cell(s) 16, and zero or more background neighboring cell(s) 18. A baseband RF converter 20 is provided that converts baseband (IF) signaling on motherboard (or internal network) of system to applicable radio frequencies in cellular bands (i.e., 1800/1900 MHz, 800/900 MHz, etc.)

The system in accordance with the principles of the present invention provides a reconstituted private network domain 21. The reconstituted private network domain 21 includes a RPN transmit subsystem 23, a RPN transmitter 25, a RPN transceiver subsystem 27, and a RPN transceiver RF distribution system 29. The RPN transceiver subsystem 27 receives Random Access Channel (RACH) and uplink dedicated control channel (“DCCH”) and Traffic Channel (TCH) information from mobile stations and forwards to controller. RACH is a standard uplink RF channel utilizing slotted aloha or similar timing algorithm to facilitate initial access between mobile stations and a radio network. TCH is a bearer services channel for transporting user data such as voice, data, and certain control-signaling channel.

The RPN transceiver RF distribution system 29 includes an antenna array 31 with placement, directional alignment (sectoring) and sensitivity specifications designed to accurately and precisely deliver RF footprint required for system operation, while keeping system within legal specifications for RF energy output. A baseband RF converter 33 is provided that converts baseband (IF) signaling on motherboard (or internal network) of system to applicable radio frequencies in cellular bands (i.e., 1800/1900 MHz, 800/900 MHz, etc.). An operator console 35 allows a user interface to all devices in system. This includes maintenance of source code and executables, files system management, configuration control of RPN and CN subsystems, fault management and diagnostics of RPN and CN subsystems, and graphical representation of aforementioned management of subsystems. The reconstituted private network domain 21 can reside and operate either in an indoor or outdoor setting, depending upon power constraints and RF optimization of the system. Conditions indoors will require RF distribution technology and techniques more consistent with indoor coverage system design. While not specifically depicted in the Figure, it is assumed that the commercial network 12 is all encompassing of both domains.

The commercial network 12 includes a CN receiver 36 connected to an antenna 39. A baseband RF converter 20 is likewise provided. The CN receiver 36 is connected to a CN receiver subsystem 38 that includes a CN receiver digital system processor (DSP) 42. The CN receiver 36 that connects to BCCH and CCCH on commercial network 12 is originally configured with a full frequency list. At start up, the CN receiver 36 scans external carrier frequencies individually as set by the internal frequency list, which is previously configured on an onboard reprogrammable flash memory device. The CN receiver 36 identifies best carrier (C/I) on the commercial network 12, connects to the BCCH associated with that carrier/cell and then proceeds to download cell BCCH data (system information).

Once scanning has completed and the CN receiver subsystem 38 has effectively camped on a cell, the CN receiver 36 monitors its neighbor cell list that was provided in the BCCH data/system information parameter download. This operates similar to that of a mobile station 10.

If the mobile station 10 is stationary, the neighbor list information will not normally change, unless RF related configuration changes are induced at the commercial network 12 (i.e., change in base station power level, new base station installed, etc.). In any case, the CN receiver 36 will monitor all neighbor cells to ensure that the system continues on the best serving cell, in accordance with the priorities listed in Table 1—Cell Measurement Criteria, below.

TABLE 1
Cell Measurement Criteria

| | | | Prob. of |
|---|---|---|---|
| | Mobile Station | Mobile Station | Remaining |
| | Measurement | Relative Received | or Becoming |
| Candidate Type | Frequency | Signal Quality (C/l + N) | Serving Cell |
| Serving Cell | High | High | High |
| foreground | Medium | Medium to High | Medium to |
| Neighbor | | | High |
| background | Low | Low to Medium | Low |
| Neighbor | | | |

The CN receiver 36 will normally monitor the CCCH; however, every few seconds the CN receiver 36 will synchronize to the BCCH timeslot to download system information, performing only a fill procedure to update the data that has changed. While this time period may be configurable depending on particular air interface specification, in a preferred embodiment this period is ten seconds is consistent with the iDEN™ network specification. iDEN is the Integrated Digital Enhanced Network (iDEN™) available from Motorola, Inc., 1303 E. Algonquin Road, Schaumburg, Ill. 60196. While one embodiment applies to iDEN, the principles of the present invention applies to Advance Mobile Phone Service (AMPS), GSM, and Time Division Multiple Access (TDMA) and all cellular air interface technologies that provide dedicated bearer service channels to requesting mobile stations. In addition, the principles of the present invention can be expanded and applied to Code Division Multiple Access (CDMA).

The CN receiver DSP 42 then reads burst data from CN receiver 36 and performs necessary Quaternary Phase Shifting Keying (“QPSK”) demodulation according to the burst data format that applies (i.e., iDEN, GSM, Electronic Industry Association Interim Standard 95 (IS-95), etc.) QPSK is a type of phase modulation using 2 pairs of distinct carrier phases, in quadrature, to signal ones and zeros.

The central processing unit (CPU) of the example system comprises controller 44. In one embodiment, the controller can be a real time embedded controller. The CN receiver DSP 42 decodes BCCH and CCCH and forwards to the controller 44. The CN receiver DSP 42 sends an interrupt service routine/request (ISR) to the controller 44. The controller 44 processes ISRs from different devices within the system via a main system bus 46. The Public Switched Telephone Network (PTSN) 48 can be interfaced by a PTSN interface module 51 via the bus 46. The controller 44 prioritizes and processes ISRs from all devices based on ISR to controller indicating that data is present, and forwards decoded burst information to controller, including full or updated BCCH data set and neighbor cell list measurement reports. The controller 44 will utilize this data to configure the RPN transceiver subsystem 27 at an appropriate frequency.

The controller 44 decodes the BCCH data set and neighbor cell list measurement reports received from the CN receiver subsystem 38. The controller 44 manipulates decoded BCCH data as follows in Table 2—Configuration Changes to Mobility Parameters:

TABLE 2
Configuration Changes to Mobility Parameters

| System Information Parameters | Change |
|---|---|
| Reselect Class neighbor cell n | Changed to zero |
| Reselect Threshold neighbor cell n in dbM | Changed to maximum |
| Handover Class neighbor cell n | Changed to zero |
| Handover Threshold neighbor cell n in dbM | Changed to maximum |

All system information relevant to the identity of the commercial network 12 (i.e., Mobile Country Code (MCC), Mobile Network Code (MCC), Location Area Identifier (LAI), etc.) remains unchanged and will be rebroadcast over the RPN transmit subsystem 23 into the reconstituted private network domain 21. The controller 44 matches the neighbor cell list with each corresponding neighbor cell list measurement reports. The controller 44 ranks each carrier in the neighbor cell list in ascending order of C/I+N.

Next, the controller 44 builds a configuration table based on this list consisting of new power levels at which each neighbor cell will be rebroadcast by the RPN transceiver subsystem 27 via the RPN transceiver RF distribution system 29. The RPN transceiver RF distribution system 29 works in combination with RPN transmit subsystem 23 to balance RF energy output requirements between system performance and any applicable legal constraints for RF energy emission. These are configurable via the operator console.

The background neighbor cell with the lowest C/I per the most recent neighbor cell list measurement report will be assigned the highest power. The second lowest power background cell will be placed in the neighbor cell list and will be configured to rebroadcast with zero power level. In the preferred embodiment, all other cells in the list will be discarded, although this can be configurable. If more than one of the same carrier frequencies exists, the one with the least propensity for co-channel interference between the reconstituted private network and the commercial network is chosen

The controller 44 also rebuilds the system information parameters into the RPN transceiver subsystem 27 configuration table. In a preferred embodiment, all neighbor cells in the commercial network decoded system information list will have all mobility classes set to zero by default, but this can be configurable. Furthermore, thresholds will be set to maximum. This will create a situation where the carrier to be broadcast over the RPN subsystem becomes the only available carrier, as set forth in Table 3—Candidate Cell List Redistribution Characteristics, below. All other cells in the neighbor cell list will be effectively barred from being reselected to as the locally configured mobility classes and thresholds have been set to detain the mobile station 10 on reconstituted private network carrier. This will effectively keep the mobile station 10 from reselecting to the commercial network 12 while it is within the confines of the reconstituted private network domain. Neighbor cells are still configured and transmitted in the system information parameter list over the RPN BCCH for future mobility and capacity management techniques.

TABLE 3
Candidate Cell List Redistribution Characteristics

| | | | Probability of Remaining or |
|---|---|---|---|
| Candidate Type | Priority | Relative Power | Becoming Serving Cell |
| background | 1 | High | 100% |
| foreground | 2 | Low to none | 0% |
| Serving | 3 | Low to none | 0% |

As such systems are deployed, RF conditions will vary as they pertain to signal qualities and power levels specifically measured by the CN receiver subsystem 38 of the commercial network 12. Higher power levels from the commercial network 12 in more densely covered areas could hinder the attraction of a mobile station 12 to the RPN transceiver subsystem, especially at power up during frequency list scan. In that case, procedures are implemented that utilize a second transmitter to inject low power interference within the confines of the reconstituted private network domain 21. Overall signal quality for the carrier frequency in question will degrade as I of C/I increases just enough for the mobile station 10 to favor the reconstituted private network carrier. Since the power level of the inducing interferer is low, this is not jamming; instead, it is an inducement designed to coax the mobile station 10 onto the private network as it further facilitates the manipulation of the C/I+N calculations of the mobile station 10. This procedure will subtly induce the mobile station 10 to move to and/or remain on the desired RPN transceiver subsystem 27 carrier frequency and provide a supplemental approach for creating a more robust system design.

Once the reconstituted data tables have been assembled, the controller 44 writes these settings to the RPN transmitter 25 of the RPN transceiver subsystem 27 in real time. The RPN transmitter 25 will set power levels according to the tables for each carrier and transmit the modified BCCH data. For initial implementation, a single transmitter is required to broadcast the BCCH channel information; however, if multiple cells are desired for future design implementations that require power levels greater than zero on reconstituted private network domain neighbor cells, additional transmitters will be required for each.

When the mobile station 10 powers up or loses sync with CN serving cell 14 for whatever reason, the mobile station 10 scans frequency list. If the mobile station 10 received signal strength (C/I) is greatest at reconstituted private network domain 21, the mobile station 10 connects to reconstituted private network domain BCCH, downloads parameters and continues normally (with reconstituted private network domain 21 parameter set). If the mobile station 10 prefers CN carrier signal strength (C/I), the mobile station 10 connects to CN BCCH, downloads parameter set, and then measures neighbors accordingly. The mobile station 10 will reselect to reconstituted private network domain 21 once it is within the reconstituted private network domain 21 per the process stated above.

As the RPN transmitter 25 broadcasts the new BCCH data over the specified frequency, any mobile station 10 within specified proximity of the RF distribution system antennas will locate and identify this signal as the preferred signal per measurement and selection procedures discussed above. The mobile station 10 will connect to the BCCH, download and decode the system information parameter set, and begin measuring the new, modified neighbor cell list. Since no location parameters have changed, the mobile station 10 will have no need to perform a location update; therefore, for cell reselections, no uplink transmissions need occur.

When a mobile station 10 attempts a call while camped on the reconstituted private network domain 21, the system will receive this and immediately assign a DCCH. Authentication does not occur since location updating has been bypassed; instead, the system will perform local authentication based not on subscriber identity characteristics, but instead on the number dialed. This will be configurable, and in a preferred embodiment the default dial plan will be an emergency number (i.e. 911). Therefore, no Home Location Register (“HLR”) or Visitor Location Registry (“VLR”) is present or necessary. HLR is the functional unit responsible for managing mobile subscribers. VLR is the functional unit responsible for managing mobile subscribers currently attached to the network. Allow/disallow decision making for calls is base on receipt of emergency dialing as decoded by the system and transmitted bi-directionally over DCCH during the mobile station 10 call attempt. The mobile station 10 will receive a message over either DCCH (bit-bucket trigger within phone) or CCCH (SMS discreet message) indicating that calls are limited to emergency only. The system will log the International Mobile Station Identity (IMSI) and Mobile Station Integrated Services Digital Network (MSISDN) for tracking purposes.

While the invention has been described with specific embodiments, other alternatives, modifications and variations will be apparent to those skilled in the art. Accordingly, it is intended to include all such alternatives, modifications and variations set forth within the spirit and scope of the appended claims.

1. A method comprising:
luring a mobile station onto a private wireless network functioning within a specified area;
filtering uplink call attempts for the purpose of identifying emergency calls;
if an emergency call is identified, processing such emergency call attempt;
controlling additional wireless communications; and
supporting delivery of wireless communications from the private wireless network for the purpose of delivering local content.

2. The method of claim 1 wherein the step of luring a mobile station onto a private wireless network includes providing from that private wireless network a foreground neighbor cell having a most preferable measurement rate such that the private wireless network provides a new serving cell.

3. The method of claim 2 further including setting neighbor cells in the commercial network to zero.

4. The method of claim 2 further including injecting low power interference within the private wireless network to degrade signal quality for the carrier frequency.

5. The method of claim 2 further including providing multiple cells in the private wireless network.

6. The method of claim 1 wherein the step of controlling wireless communications further comprises inhibiting incoming calls.

7. The method of claim 1 wherein the step of controlling wireless communications further comprises inhibiting outgoing calls.

8. The method of claim 1 wherein the step of controlling wireless communications further comprises prohibiting wireless communications.

9. The method of claim 1 wherein the step of controlling wireless communications further includes prohibiting paging.

10. The method of claim 1 further wherein the step of supporting delivery of wireless communications from the private wireless network for the purpose of delivering local content comprises enabling Short Messaging Service (SMS).

11. The method of claim 1 further wherein the step of supporting delivery of wireless communications from the private wireless network for the purpose of delivering local content comprises enabling Wireless Application Protocol (WAP).

12. The method of claim 1 further wherein the step of supporting delivery of wireless communications from the private wireless network for the purpose of delivering local content comprises enabling pop-up ads.

13. The method of claim 1 further wherein the step of supporting delivery of wireless communications from the private wireless network for the purpose of of delivering local content comprises processing incoming calls that have been generated from within.

14. The method of claim 1 further wherein the step of supporting delivery of wireless communications from the private wireless network for the purpose of of delivering local content comprises filtering incoming calls from the outside.

15. A method comprising:
characterizing an existing commercial network;
configuring a private wireless network with system information from the existing commercial network;
rebroadcasting modified system information on the private wireless network;
commmunicating with a mobile station service requests over the private wireless network.

16. The method of claim 15 further including the step of the private wireless network inhibiting incoming calls.

17. The method of claim 15 further including the step of the private wireless network inhibiting outgoing calls.

18. The method of claim 15 further including the step of the private wireless network filtering wireless communications.

19. The method of claim 18 wherein the step of filtering communications further comprises allowing emergency communications.

20. The method of claim 15 further including the step of the private wireless network prohibiting wireless communications.

21. The method of claim 15 further including the step of the private wireless network prohibiting paging.

22. The method of claim 15 further including the step of the private wireless network enabling local content services.

23. The method of claim 22 further wherein the step of enabling local content services comprises enabling Short Messaging Service (SMS).

24. The method of claim 22 further wherein the step of enabling local content services comprises enabling Wireless Application Protocol (WAP).

25. The method of claim 22 further wherein the step of enabling local content services comprises enabling pop-up ads.

26. The method of claim 15 further including setting neighbor cells in the commercial network to zero.

27. The method of claim 15 further including injecting low power interference within the private subsystem to further induce reselection from the commercial network to the private network.

28. The method of claim 15 further including the private wireless network functioning within a specified area.

29. The method of claim 15 further including providing multiple cells in the private wireless network.

30. A system comprising:
a central controller;
a network transceiver subsystem; and
an antenna array having directional alignment and sensitivity specifications designed to deliver a radio frequency footprint, while keeping system within legal specifications for radio frequency energy output,
such that a private wireless network is established.

31. The system of claim 30 further wherein the private wireless network inhibits incoming calls.

32. The system of claim 30 further wherein the private wireless network inhibits outgoing calls.

33. The system of claim 30 further wherein the private wireless network filters wireless communications.

34. The system of claim 33 wherein the step of filtering communications further comprises allowing emergency communications.

35. The system of claim 30 further wherein the private wireless network prohibits wireless communications.

36. The system of claim 30 further wherein the private wireless network prohibits paging.

37. The system of claim 30 further wherein the private wireless network enables local content services.

38. The system of claim 37 further wherein the local content services comprises Short Messaging Service (SMS).

39. The system of claim 37 further wherein the local content services comprises Wireless Application Protocol (WAP).

40. The system of claim 37 further wherein the step of enabling local content services comprises enabling pop-up ads.

41. The system of claim 30 further wherein the private wireless network sets neighbor cells in the commercial network to zero.

42. The system of claim 30 further wherein the private wireless network injects low power interference to degrade signal quality for the carrier frequency.

43. The system of claim 30 further wherein the private wireless network includes multiple cells.

44. A method comprising:
luring a mobile station from its service provider network to a private wireless network by providing a foreground neighbor cell having a most preferable measurement rate such that the private wireless network provides a new serving cell; and
controlling the communications from that mobile station.

45. The method of claim 44 wherein the mobile station is a cellular telephone.

46. The method of claim 44 wherein the step of controlling communications further comprises inhibiting wireless communications.

47. The method of claim 46 wherein the step of inhibiting communications further comprises inhibiting incoming calls from the service provider network.

48. The method of claim 46 wherein the step of inhibiting communications further comprises inhibiting outgoing calls from the service provider network.

49. The method of claim 44 wherein the step of controlling communications further comprises filtering wireless communications.

50. The method of claim 49 wherein the step of filtering communications further comprises allowing emergency communications.

51. The method of claim 44 wherein the step of controlling communications further comprises, prohibiting wireless communications from the service provider network.

52. The method of claim 44 wherein the step of controlling communications further includes prohibiting paging from the service provider network.

53. The method of claim 44 further including the step of the private wireless network enabling local content services.

54. The method of claim 53 further wherein the step of enabling local content services comprises enabling Short Messaging Service (SMS).

55. The method of claim 53 further wherein the step of enabling local content services comprises enabling Wireless Application Protocol (WAP).

56. The method of claim 53 further wherein the step of enabling local content services comprises enabling pop-up ads.

57. The method of claim 44 further including the private wireless network setting neighbor cells in the commercial network to zero.

58. The method of claim 44 further including the private wireless network injecting low power interference to further induce reselection from the commercial network to the private network.

59. The method of claim 44 further including providing multiple cells in the private wireless network.

60. A method comprising:
luring a mobile station from its service provider network to a private substation by setting neighbor cells in the commercial network to zero such that the private subsystem provides a new serving cell; and
controlling the communications from that mobile station.

61. A method comprising:
luring a mobile station from its service provider network to a private subsystem network by injecting low power interference within the private subsystem to induce reselection from the commercial network to the private network degrade signal quality for the carrier frequency of commercial network such that the private network provides a new serving cell; and
controlling the communications from that mobile station.
